(19) United States
(12) Patent Application Publication
(10) Pub. No.: US 2008/0123090 A1
(43) Pub. Date: May 29, 2008

(54) DEVICE AND METHOD TO TRANSFER OBJECTS FOR OPTICAL ANALYSIS

(75) Inventor: Binayak Roy, Santa Clara, CA (US)

Correspondence Address: PETER VOGEL;GE HEALTHCARE, 3000 N. GRANDVIEW BLVD., SN-477, WAUKESHA, WI, 53188, US

(73) Assignee: GENERAL ELECTRIC COMPANY, Schenectady, NY (US)

(21) Appl. No.: 11/563,301

(22) Filed: Nov. 27, 2006

(51) Int. Cl. G01N 21/01

(52) U.S. Cl. 356/244

(57) ABSTRACT

An imaging system for analysis of at least one object is provided. The imaging system includes an optical detector, and a tray device received at the system. The tray device includes an aqueous media contained in at least one well defined by the tray device. The aqueous media in a fluid state allows the at least one object to pass through toward a lowermost surface of the well. Yet, exposure of the aqueous media to an ultraviolet light polymerizes the aqueous media to a solid state such that the aqueous media prevents movement of the at least one object relative to the well.

### BACKGROUND OF THE INVENTION

This invention generally relates to a storage device, and more specifically to a device for supporting a sample for examination with fluoroscopic imaging system with reduced leaks and evaporation.

Various storage devices have been developed to support shipment of various objects, including biological samples or fluorescent beads, to laboratories for examination or analysis with, or calibration of, an optical imaging system. A certain storage device includes defined fluorescent objects to be used in the calibration and alignment of a fluoroscopic imaging system. The fluorescent objects are configured as beads of defined diameters and fluorescent properties. The beads are placed in a generally transparent aqueous media and spun down to a desired position at a bottom of a well of the storage device so as to be analyzed in calibrating the imaging system.

However, there are several drawbacks with conventional storage devices configured to support shipment of objects or samples for examination or analysis with an optical imaging system. In one example, the conventional storage devices do not adequately restrain movement of the objects or samples during transportation in a desired manner for later examination or analysis with the optical system. In regard to the certain storage device for the objects or samples shipped for examination with the fluoroscopy imaging system described above, known storage devices do not adequately restrain movement of the object (e.g., fluorescent beads) from the desired locations for examination and analysis by the fluoroscopic imaging system if the storage device is tilted at angle for an extended time period.

Also, objects (e.g., the fluorescent beads) retained in the storage devices are known to be susceptible to Brownian motion in the aqueous media, further increasing opportunities for undesired movement or re-suspension of the objects from a desired position in the well of the storage device. In yet another example, aqueous media employed to receive the objects or samples is typically known to evaporate. In still yet another example, lids or sealants of these certain known storage devices are generally known to have an increased risk of leaking the aqueous media, and/or objects or samples stored therein, with changes in air pressure such as experienced in a cargo hull of an airplane.

### BRIEF DESCRIPTION OF THE INVENTION

The above-mentioned drawbacks and needs are addressed by the embodiments described herein in the following description.

In accordance with one embodiment of the subject matter described herein, a tray device to retain at least one object for analysis with an optical imaging system having a light source is provided. The tray device includes an aqueous media to receive the at least one object, and at least one well defined in the tray device to receive the aqueous media. The aqueous media includes a liquid state such that the object passes through toward a lowermost surface of the well. Yet, exposure of the aqueous media to an activation media polymerizes the aqueous media to a solid state such that the aqueous media restrains movement of the at least one object relative to the well for any alignment of the device.

An embodiment of a method of transferring at least one object for examination with an imaging system is also provided. The method includes the acts of receiving at least one object in an aqueous media retained in a well of a tray device; passing the at least one object through the aqueous media toward a lowermost point of the well; and polymerizing the aqueous media while the at least one object is located at the lowermost point of the well so as to prevent re-suspension of the object with any change in orientation of the well.

Also, an embodiment of an optical imaging system for analysis of at least one object is provided. The system includes an optical detector, and a tray device received at the system. The tray device includes an aqueous media contained in at least one well defined by the tray device. The aqueous media in a liquid state passes the at least one object through toward a lowermost surface of the well of the tray device. Exposure of the aqueous media to an activation medium polymerizes the aqueous media to a solid state such that the aqueous media prevents movement of the at least one object relative to the well.

Systems and methods of varying scope are described herein. In addition to the aspects and advantages described in this summary, further aspects and advantages will become apparent by reference to the drawings and with reference to the detailed description that follows.

### BRIEF DESCRIPTION OF THE DRAWINGS

FIG. 1 shows a schematic diagram of an embodiment of a storage device configured to retain at least one object or sample for analysis with an optical imaging system.

FIG. 2 illustrates a detailed schematic diagram of an embodiment of the storage device shown in FIG. 1.

### DETAILED DESRIPTION OF THE INVENTION

In the following detailed description, reference is made to the accompanying drawings that form a part hereof, and in which is shown by way of illustration specific embodiments, which may be practiced. These embodiments are described in sufficient detail to enable those skilled in the art to practice the embodiments, and it is to be understood that other embodiments may be utilized and that logical, mechanical, electrical and other changes may be made without departing from the scope of the embodiments. The following detailed description is, therefore, not to be taken in a limiting sense.

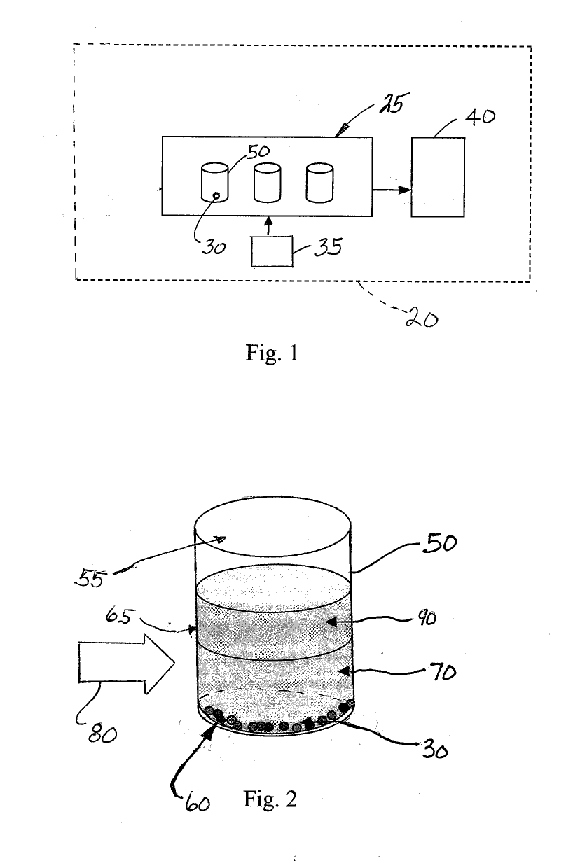

FIG. 1 illustrates one embodiment of a system 20 that includes device 25 configured to retain an object 30 for analysis or examination by the system 20. The system 20 is generally configured to view or analyze the object 30 retained at the device 25. An embodiment of the system 20 includes a line-scanning, confocal microscope having a light source 35 in combination with a detector 40 so as to optically analyze the object 30 retained at the device 25. The light source 35 can be operable to generate a scanning beam (e.g., laser or multiple lasers) of infrared, ultraviolet, or other selected wavelength spectrum of radiation or combination of wavelengths of radiation to be targeted at the object 30. The detector 40 can be a photo detector located to receive and detect the impinging energy (e.g., light emission) generated by targeting the laser or beam of light at the at least one object 30.

An example of the system 20 is for cell-imaging analysis, such as an IN Cell Analyzer 3000 as manufactured by GE Healthcare®, operable to perform cellular assays that includes imaging or quantification of sub-cellular events for display as histograms, scatter plots, time-traces, and movies. The system 20 can include a fluoroscopic, line-scanning confocal microscope with a multi-wavelength light source 35 (e.g., infrared, ultraviolet, modulated, un-modulated, multiple argon or krypton laser, beam-splitter, etc.) in combination with a respective multi-wavelength photo detector 40 (e.g., camera or multiple cameras) to analyze objects 30 in a defined area of the device 25. The location of the light source 35 relative to the detector 40 can vary. Also, it should be understood that the type of system 20 can vary.

It should be understood that the term object 30 referred to herein can be one or a series of objects. The object 30 is of general dimension to be retained in the device 25 for examination by the system 20. One embodiment of the object 30 is bead-shaped and comprised of a fluorescent material to be used as a calibration standard for the system 20. Although this description and illustration refers to the object 30 as a calibration standard for the system 20, the object 30 is not so limited. For example, another embodiment of the object 30 can be a biological sample retained in the device 25 for analysis by the system 20. Thus, it should be understood that the type (e.g., organic, inorganic, fluorescent, etc.) of object 30 can vary.

The device 25 retaining the object 30 is generally configured to be received and docked at the system 20 for analysis of the object 30. An embodiment of the device 25 is a tray device that defines a series of wells 50. A particular embodiment of the device includes ninety-six wells 50. Yet, the number of wells 50 can vary. Each well 50 generally defines an upper open face 55 to the atmosphere opposite a lowermost surface 60, with a sidewall 65 extending therebetween. At least the portion of the device defining the series of wells 50 is generally comprised of a composition such as plastic (e.g., polystyrene) or glass or other similar material that is generally transparent so as to allow light from the light source 35 of the system 20 employed in the analysis of the object 30 pass through.

An aqueous media 70 is generally retained in each well 50 of the tray device 25 so as to receive and retain the object 30. A depth of the aqueous media 70 can vary, but is illustrated as at least covering or immersing the object 30. The aqueous media 70 is generally transparent so as to allow transmission of light employed by the system 20 in the analysis of the object 30 to pass through. In accordance with one embodiment, the aqueous media 70 includes a fluid state which passes the at least one object 30 through toward the lowermost surface 60 of the well 50. Yet, exposure of the aqueous media 70 to an activation medium 80 causes polymerizing of the aqueous media 70 to a more rigid, solid state such that the aqueous media 70 generally prevents or restrains re-suspension or other movement of the at least one object 30 relative to the well 50 with any alignment or orientation of the well 50 and the device 25, under normal temperature and pressure conditions or under lowered temperature, lowered pressure conditions associated with air transportation or shipment. Accordingly, the aqueous media 70 in this more rigid, solid state holds or restrains the at least one object 30 being used as a calibration standard at a desired location at the lowermost surface 60 of the well 50 of the device 25 for examination by the detector 40 of the system 20. In both the fluid and solid states, the aqueous media has a refractive index relative to air that is close to water (i.e., refractive index of 1.3) and in a positive range of about 1.0-5.0.

One embodiment of the aqueous media 70 includes a polymerization agent in combination with a buffered saline solution. An embodiment of the polymerization agent includes an acrylamide and bis-acrylamide composition at about a ratio of 30:1 (e.g., about four percent of the aqueous media) in combination with a 2-Hydroxy-1-[4-(2-hydroxyethoxy)phenyl]-2methyl-1-propane composition. The aqueous media 70 is at least ninety-five percent aqueous, and a particular embodiment is about ninety-eight percent aqueous. In response to exposure to the activation medium 80, the polymerization agent is generally operable to polymerize or branch across the aqueous media 70 and cause transformation of the aqueous media 70 from the generally fluidic state to the generally more rigid, solid state. An embodiment of the activation medium 80 includes ultraviolet light. The ultraviolet light as the activation medium 80 allows the aqueous media 70 to remain in the fluid state at least until the object 30 is positioned as desired in the well 50. Once object 30 is position as desired in the well 50, exposing the aqueous media 70 to the ultraviolet light gels or polymerizes the aqueous media 70 to the more rigid, solid state such that the object 30 is restrained by the media 70 from movement relative to the well 50. Yet, the types of polymerization agents that are activated by other types of activation medium 80 (e.g., portion of electromagnetic radiation spectrum such as ultraviolet light, chemical agents, temperature, etc.) can alternatively be used. For example, an Acrylamide/Bis-Acrylamide composition can be catalyzed by a chemical agent, such as Tetramethylethylenediamine (TEMED) and ammonium persulfate. In addition, the polymerization agent can include crosslinked polymers (e.g., CARBOPOL®) operable to be dissolved in the aqueous media 70 and later polymerized to form a gel caused by neutralizing with a base such as sodium hydroxide or triethaneamine (TEA).

The device 20 further includes a sealant layer 90 located such that the aqueous media 70 is between the sealant layer 90 and the lowermost surface 60 of the well 50. An embodiment of the sealant layer 90 is in one phase operable to flow over the aqueous media 70, and is configured to polymerize to a second phase such that the sealant layer 90 is generally impermeable to the aqueous media 70. The sealant layer 90 is generally configured to prevent leakage or evaporation of the aqueous media 70 under normal atmospheric and temperature conditions, as well as atmospheric and temperature conditions encountered during air transportation or shipment. An example of the sealant layer 90 is comprised of a silicone rubber material or a composition of silicone, such as poly-dimethoxy siloxane as manufactured by DOW-CORNING® Corporation. The sealant layer 90 also includes a polymerization agent. When the polymerized agent is not activated, the sealant layer 90 is in a fluid state so as to be placed over the aqueous media 70. Activation of the polymerized agent polymerizes the sealant layer 90 to more rigid, solid state that is generally impermeable to the aqueous media 70 under the above-described temperature and pressure conditions and generally fixed with respect to the well 50. Yet, other types of sealant materials that are generally impermeable to the aqueous media 70 under the above-described conditions can be used. For example, the sealant layer 90 can be transparent or non-transparent (e.g., aluminum foil, black tape, a black silicone composition that reduces transmission of light, etc.). A non-transparent sealant layer 90 may be desired to reduce transmission of ambient light through to the object 30 at the bottom of the well 50 and to reduce any light induced degradation. Accordingly, the light source 35 and detector 40 can be located under the well 50 such that the sealant layer 90 does not need to be transparent. It should be understood that a thickness or number of sealant layer 90 can also vary.

Having described the general construction of the system 20 to analyze the at least one object 30, the following is a description of a method of handling the at least one object 30 for examination with the system 20. It should be understood that the foregoing sequence of acts comprising the method can vary and may performed simultaneously, that the method may need to include each and every act in the following description, and the method can include additional acts not disclosed in the following description.

Assume the at least one object 30 is a series of fluorescent beads, and is to be shipped via air transportation to a remote location for use as a calibration standard by optical analysis system 20. The method includes receiving the series of objects 30 in a series of wells 50 retaining an aqueous media 70. The aqueous media 70 is in a fluidic state, passing the series of objects 30 through toward a lowermost surface 60 of each well 50 of the tray device 25. In accordance with one embodiment of the method, the at least one object 30 passes through the aqueous media 70 toward the lowermost surface 60 of the well 50 while spinning the well 50.

With the at least one object 30 located at the lowermost surface 60 of the well 50, the aqueous media 70 is polymerized to a new more rigid state or solid state so as to prevent movement and re-suspension of the object 30 relative to the well 50. The polymerized aqueous media 70 is of such rigidity so as to prevent movement of the at least one object 30 with any change in orientation or alignment of the well 50 of the tray device 25. One embodiment of act of polymerizing includes exposing the aqueous media 70 to the activation medium 80, such as ultraviolet or infrared light.

The sealant layer 90 is placed against the polymerized aqueous media 70 such that the aqueous media 70 is between the sealant layer 90 and the lowermost surface 60 of the well 50. The light source 35 and detectors 40 can be located at various positions so as to illuminate and acquire images of the object 30 at the lowermost surface 60 of the well 50. For example, if the well 50 includes a non-transparent sealant material 90 and has a generally transparent lowermost surface 60, then optical imaging light to allow image acquisition or ultraviolet light to polymerize the aqueous media 70 can be provided through the lowermost surface 60 of the well 50. Accordingly, the aqueous media 70 can be polymerized to the more rigid, solid state before or after the sealant layer 90 is placed in the tray device 25. The sealant layer 90 is impermeable to the aqueous media 70, preventing evaporation or leakage of the aqueous media 70 during ground or air shipment, or spillage associated with instrument handling operations.

In accordance with the above-description, the embodiments of the device 25 adequately restrain movement of the object 30 from a desired position during ground or air transportation in a desired manner for later examination or analysis with the optical analysis system 20, even if the well 50 or device 25 is tilted or orientated any angle for an extended time period. Accordingly, the objects 30 (e.g., the fluorescent beads) retained in the devices 25 are not susceptible to Brownian motion in the aqueous media 70 during transportation, preventing opportunities for undesired movement or re-suspension of the objects 30 from desired positions at the lowermost surface 60 of the well 50.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A tray device to retain at least one object for analysis with an optical analysis system having a light source, comprising:
an aqueous media to receive the at least one object; and
at least one well defined in the tray device to receive the aqueous media,
wherein the aqueous media in a fluid state allows the at least one object to pass through toward a lowermost surface of the well, and wherein exposure of the aqueous media to an activation medium polymerizes the aqueous media to a solid state such that the aqueous media prevents movement of the at least one object relative to the well.

2. The tray device of claim 1, further comprising a sealant layer that is generally impermeable to the aqueous media, wherein the sealant layer is located such that the aqueous media is between the sealant layer and the lowermost surface of the well.

3. The tray device of claim 2, wherein the sealant layer is comprised of at least one of a silicone rubber material, a composition of silicone, and a polymerization agent.

4. The tray device of claim 2, wherein the sealant layer is generally transparent to light generated by the light source of the optical imaging system.

5. The tray device of claim 1, wherein the aqueous media in the fluid and solid states has a refractive index relative to air in a positive range of about 1.0-5.0.

6. The tray device of claim 1, wherein the at least one object is bead-shaped and comprised of a fluorescent material composition such that the tray device is a calibration standard for the optical imaging system.

7. The tray device of claim 1, wherein the aqueous media comprises a polymerization agent, the polymerization agent comprising at least one of a group consisting of an acrylamide composition, a bis-acrylamide composition, and a 2-Hydroxy-1-[4-(2-hydroxyethoxy)phenyl]-2methyl-1-propane composition that polymerizes the aqueous media when exposed to the activation medium.

8. The tray device of claim 1, wherein the activation medium includes ultraviolet light, and wherein the polymerization agent is reactive to exposure to the ultraviolet light so as to cause polymerizing of the aqueous medium to the solid phase.

9. The tray device of claim 1, wherein the activation medium includes one of a group consisting of an ultraviolet light and a chemical agent.

10. A method of handling at least one object for examination with an optical analysis system, the method comprising the acts of:
receiving at least one object in an aqueous media retained in a well of a tray device;
passing the at least one object through the aqueous media toward a lowermost point of the well; and
polymerizing the aqueous media while the at least one object is located at the lowermost point of the well so as to prevent re-suspension of the object with any change in orientation of the well.

11. The method of claim 10, wherein the aqueous media comprises a polymerization agent comprising at least one of a group consisting of an acrylamide composition, a bis-acrylamide composition, and a 2-Hydroxy-1-[4-(2-hydroxyethoxy)phenyl]-2methyl-1-propane composition, and wherein the polymerization agent operable to polymerize the aqueous media in response to exposure to an activation medium.

12. The method of claim 10, wherein the act of polymerizing includes exposing the aqueous media to an activation medium.

13. The method of claim 12, wherein the activation medium is one of a group consisting of an ultraviolet light and a chemical agent.

14. The method of claim 10, wherein the act of passing the at least one object through the aqueous media toward the lowermost point of the well includes spinning the well.

15. The method of claim 10, the method further comprising the act of:
placing a sealant layer against the aqueous media such that the aqueous media is between the sealant layer and a lowermost point of the well.

16. The method of claim 15, wherein the sealant layer is generally impermeable to the aqueous media.

17. The method of claim 15, wherein the sealant layer is comprised of a silicone rubber material and a polymerization agent.

18. The method of claim 15, wherein the sealant layer is generally non-transparent.

19. The method of claim 10, wherein the at least one object is generally bead-shaped and is comprised of a generally fluorescent material composition.

20. A confocal imaging system for analysis of at least one object, comprising:
a photo detector;
a tray device received at the system, the tray device including:
an aqueous media contained in at least one well defined by the tray device, wherein the aqueous media in a fluid state allows the at least one object to pass through toward a lowermost surface of the well, and wherein exposure of the aqueous media to an activation medium polymerizes the aqueous media to a solid state such that the aqueous media prevents movement of the at least one object relative to the well.
